(19) United States
(12) Patent Application Publication
(10) Pub. No.: US 2010/0126532 A1
(43) Pub. Date: May 27, 2010

(54) SUBSTRATE PROCESSING APPARATUS AND SUBSTRATE PROCESSING METHOD

(75) Inventors: Osamu TAMADA, Kyoto (JP); Masakazu SANADA, Kyoto (JP)

Correspondence Address: OSTROLENK FABER GERB & SOFFEN, 1180 AVENUE OF THE AMERICAS, NEW YORK, NY, 100368403, US

(73) Assignee: DAINIPPON SCREEN MFG. CO., LTD, Kyoto (JP)

(21) Appl. No.: 12/694,759

(22) Filed: Jan. 27, 2010

Related U.S. Application Data
(62) Division of application No. 11/081,266, filed on Mar. 16, 2005.

(30) Foreign Application Priority Data
Mar. 16, 2004 (JP) JP2004-074547

(51) Int. Cl. B08B 3/00

(52) U.S. Cl. 134/26

(57) ABSTRACT

A processing solution supply nozzle is moved relatively from one end to the opposite end of a semiconductor wafer having undergone a developing operation while discharging an anti-static processing solution in a discharge width equal to or greater than the width of the semiconductor wafer. The anti-static processing solution is thereby supplied onto the semiconductor wafer. The prevention of charging of the substrate avoids the occurrence of defects. The processing solution supplied almost uniformly on the entire surface of the substrate also avoids the occurrence of defects.

### BACKGROUND OF THE INVENTION

1. Field of the Invention

The present invention relates to a substrate processing apparatus and a substrate processing method for supplying a predetermined processing solution onto a substrate such as a semiconductor wafer, a glass substrate for liquid crystal display panel and a glass substrate for plasma display panel.

2. Description of the Background Art

In a developing operation of a semiconductor resist, a developer such as an alkaline solution is supplied onto a wafer to produce a development reaction for a predetermined time period, and then, pure water is discharged as a rinse water onto the wafer to finish the development reaction.

Conventionally, pure water is discharged with the leading edge of a pipe-like nozzle directed toward a surface of a wafer employing a method of rotating the wafer for spreading pure water across the wafer (first technique).

However, it has been found out that, when discharging pure water while rotating a wafer as described above, the rotation causes triboelectric charging of the wafer, which causes charged particles included in a solution to adhere to the wafer surface, resulting in post-develop defects.

Accordingly, a method has been considered in which pure water is supplied onto the entire surface of a wafer held stationary or almost stationary by allowing a nozzle having a slit-like discharge port to pass over the wafer (second technique; e.g., Japanese Patent Application Laid-Open No. 2003-100601).

This method, in which the wafer is held stationary or almost stationary, can avoid triboelectric charging of the wafer, which is therefore expected to reduce post-develop defects.

On the other hand, to prevent a charging phenomenon of a wafer, a method of using pure water with CO₂ gas dissolved therein as a rinse water is known (third technique; e.g., Japanese Patent Application Laid-Open No. 60-165726 (1985)).

However, studies by trial and error made by inventors of the present invention have revealed the following problems.

More specifically, it has been revealed that the above-mentioned second technique cannot perfectly avoid charging due to the flow of pure water, and thus cannot limit the occurrence of post-develop defects not to exceed a certain degree.

Further, it has been revealed that the third technique cannot supply a uniform amount of rinse water onto the entire surface of a wafer, and particularly, defects tend to occur in the vicinity of the wafer edge to which a relatively small amount of rinse water is supplied.

Furthermore, it has been revealed that, among a great many of resists for use in lithography, some tend to cause post-develop defects rather by employing the method of supplying pure water with CO₂ gas dissolved therein as described in JP 60-165726 mentioned above. According to the inventors' studies, this is because a sudden mixture of an aqueous CO₂ solution, which is acid, into a developer, which is alkaline, results in neutralization to cause precipitation of a resist dissolved in the developer.

### SUMMARY OF THE INVENTION

This invention is directed to a substrate processing apparatus or a substrate processing method for supplying a processing solution onto a substrate.

According to a first aspect of the present invention, the substrate processing apparatus for supplying a processing solution onto a main surface of a substrate includes a substrate holding element for holding the substrate almost in a horizontal position, a processing solution supply nozzle having a discharge port for discharging the processing solution in a discharge width substantially equal to or greater than a width of the substrate, a processing solution supply element for supplying an anti-static processing solution as the processing solution to the processing solution supply nozzle, and a nozzle moving element for moving the processing solution supply nozzle from one end to the opposite end of the semiconductor wafer so as to pass over the semiconductor wafer.

The processing solution supply nozzle having the discharge port for discharging the anti-static processing solution in a predetermined discharge width passes over the substrate, so that the anti-static processing solution is supplied onto the entire surface of the substrate almost uniformly without spinning the substrate. The prevention of charging of the substrate avoids the occurrence of defects. The processing solution supplied almost uniformly on the entire surface of the substrate also avoids the occurrence of defects.

According to a second aspect of the present invention, the substrate processing method of supplying a processing solution onto a main surface of a substrate includes the following steps (a) and (b). The step (a) is to discharge an anti-static processing solution in a discharge width substantially equal to or greater than a width of the substrate. The step (b) is to scan the substrate from one end to the opposite end, thereby supplying the anti-static processing solution onto the substrate. The steps (a) and (b) are performed concurrently.

The substrate is scanned from one end to the opposite end while discharging the anti-static processing solution onto the substrate in a discharge width substantially equal to or greater than the width of the substrate. This can make it possible to supply the anti-static processing solution onto the entire surface of the substrate almost uniformly without spinning the substrate. The prevention of charging of the substrate avoids the occurrence of defects. The processing solution supplied almost uniformly on the entire surface of the substrate also avoids the occurrence of defects.

According to a third aspect of the present invention, the substrate processing apparatus for supplying a processing solution onto a main surface of a substrate having undergone a developing operation includes a substrate holding element for holding the substrate almost in a horizontal position, a first processing solution supply nozzle having a discharge port for discharging a first processing solution in a discharge width substantially equal to or greater than a width of the substrate, a development stop liquid supply element for supplying a development stop liquid, as the first processing solution, for stopping a development reaction to the first processing solution supply nozzle, a nozzle moving element for moving the first processing solution supply nozzle from one end to the opposite end of the substrate so as to pass over the substrate, a second processing solution supply nozzle for discharging a second processing solution onto the substrate, and an anti-static cleaning solution supply element for supplying an anti-static cleaning solution to the second processing solution supply nozzle as the second processing solution. The anti-static cleaning solution is supplied from the second processing solution supply nozzle after the development stop liquid is supplied from the first processing solution supply nozzle.

The anti-static cleaning solution is supplied onto the substrate after the development stop liquid is supplied. Therefore, it is possible to avoid generation of reactants of the developer and anti-static cleaning solution, and thus avoid the occurrence of defects.

According to a fourth aspect of the present invention, the substrate processing method of supplying a processing solution onto a main surface of a substrate having undergone a developing operation includes the following steps (c) and (d). The step (c) is to supply a development stop liquid onto the substrate having undergone the developing operation. The step (d) is to supply an anti-static cleaning solution onto the substrate after the step (c).

The anti-static cleaning solution is supplied onto the substrate after supplying the development stop liquid onto the substrate having undergone the developing operation. Therefore, it is possible to avoid generation of reactant of the developer and anti-static cleaning solution, and thus avoid the occurrence of defects.

It is therefore an object of the present invention to reduce the occurrence of operating defects to a minimum when supplying a processing solution on to a substrate.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 s a plan view schematically showing a construction of a substrate processing apparatus according to a first preferred embodiment of the present invention;

FIG. 2 is a side view schematically showing the construction of the substrate processing apparatus according to the first preferred embodiment;

FIG. 3 is a sectional view taken along the line III-III of FIG. 1;

FIG. 4 shows a discharge port provided for a developer supply nozzle;

FIGS. 5 and 6 are enlarged views of an essential part showing the developer supply nozzle and a processing solution supply nozzle;

FIG. 7 shows a developer supply system;

FIG. 8 shows a processing solution supply system;

FIG. 9 is a block diagram showing an electrical configuration of the substrate processing apparatus according to the first preferred embodiment;

FIG. 10 is a flow chart showing a series of steps of a developing operation performed by the substrate processing apparatus according to the first preferred embodiment;

FIG. 11 is an explanatory view showing the movement of the developer supply nozzle;

FIG. 12 is an explanatory view showing the movement of the processing solution supply nozzle;

FIG. 13 is an explanatory view showing a relative movement of the processing solution supply nozzle with respect to a semiconductor wafer;

FIG. 14 is an explanatory view showing a state of supplying a processing solution;

FIG. 15 is an explanatory view showing another state of supplying the processing solution;

FIG. 16 shows a processing solution supply system of a substrate processing apparatus according to a second preferred embodiment of the present invention;

FIG. 17 shows an anti-static cleaning solution supply system of the substrate processing apparatus according to the second preferred embodiment;

FIG. 18 is a flow chart showing a series of steps of a developing operation performed by the substrate processing apparatus according to the second preferred embodiment;

FIG. 19 shows a variant of a method of moving a processing solution supply nozzle; and

FIG. 20 shows another variant of the method of moving a processing solution supply nozzle.

### DESCRIPTION OF THE PREFERRED EMBODIMENTS

### First Preferred Embodiment

A substrate processing apparatus and a substrate processing method according to a first preferred embodiment of the present invention will be discussed hereinbelow. This first preferred embodiment is directed to a substrate processing apparatus and a substrate processing method in which a developer is supplied onto a substrate to cause a development reaction for a certain time period, and then an anti-static processing solution is supplied using a so-called slit-scan technology.

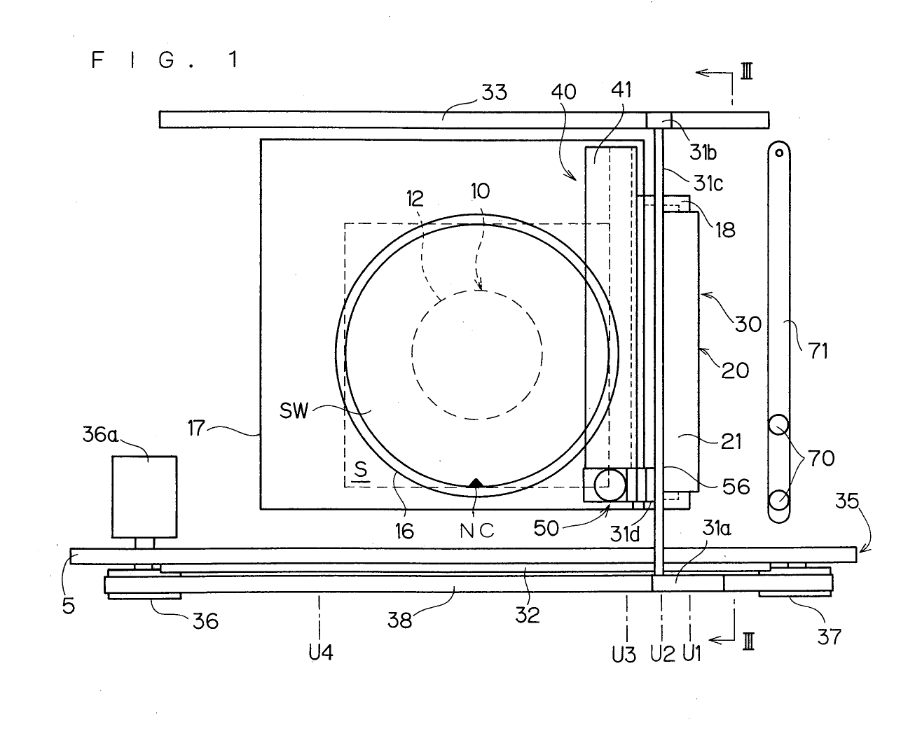

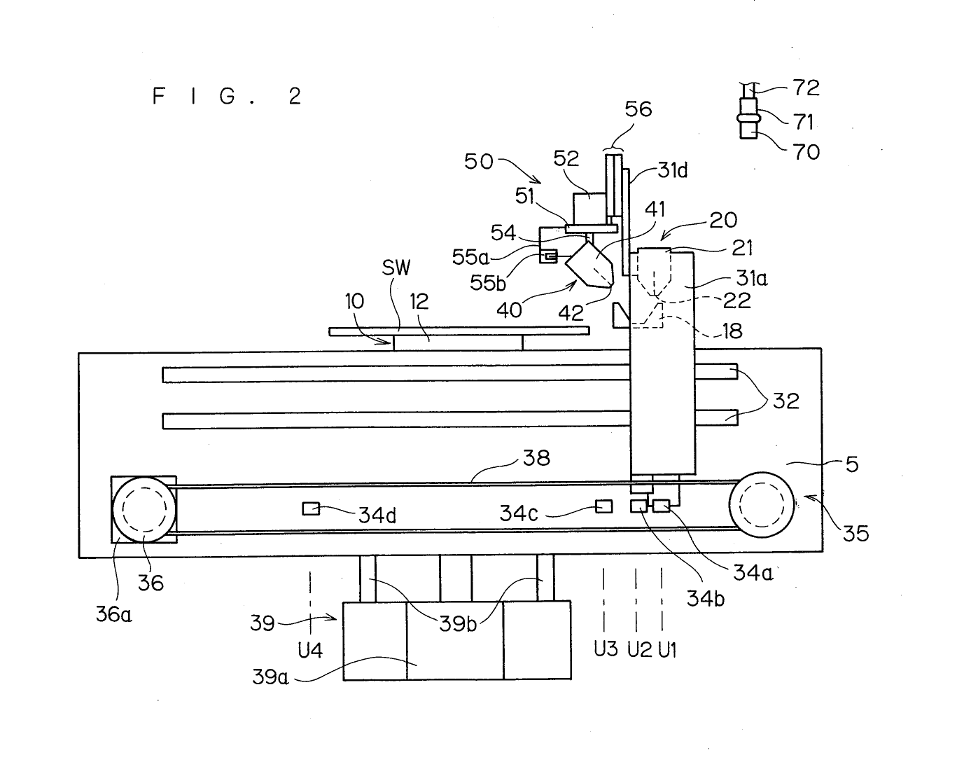

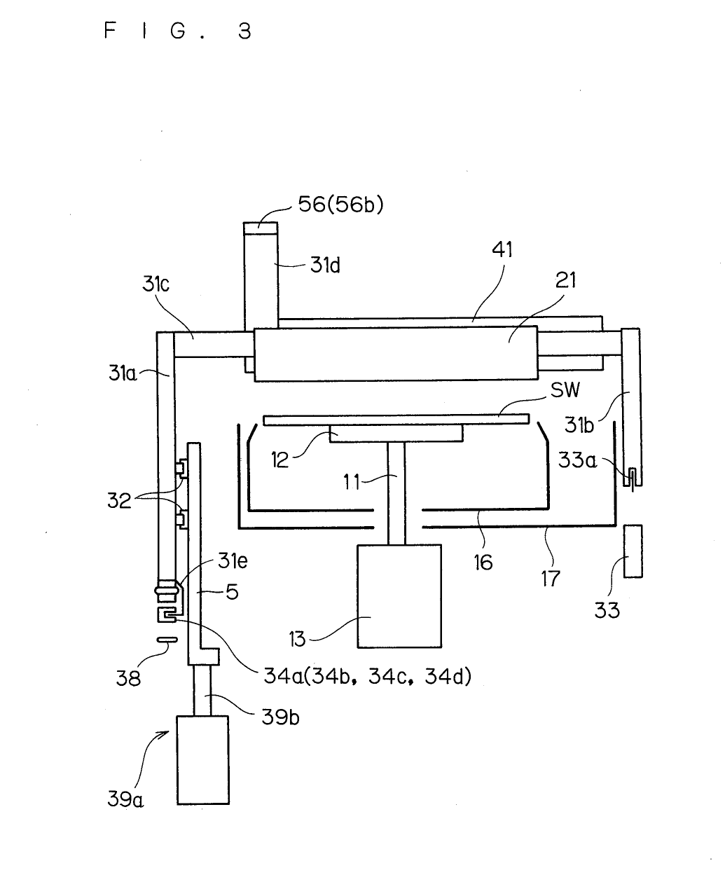

FIG. 1 is a plan view schematically showing a construction of the substrate processing apparatus. FIG. 2 is a side view schematically showing the construction of the substrate processing apparatus. FIG. 3 is a sectional view taken along the line III-III of FIG. 1. In FIG. 3, a section for holding a substrate is also shown in cross section.

This substrate processing apparatus is an apparatus for developing a resist thin film formed on a surface of a semiconductor wafer SW which is a substrate. Prior to a developing operation performed by this apparatus, the resist thin film is exposed to light by an exposure apparatus so that a predetermined pattern is formed thereon.

The semiconductor wafer SW to be processed is a substantially circular plate, having a diameter of 200 mm or 300 mm, for example. Further, the semiconductor wafer SW has a notch NC or orientation flat partly formed on its outer periphery.

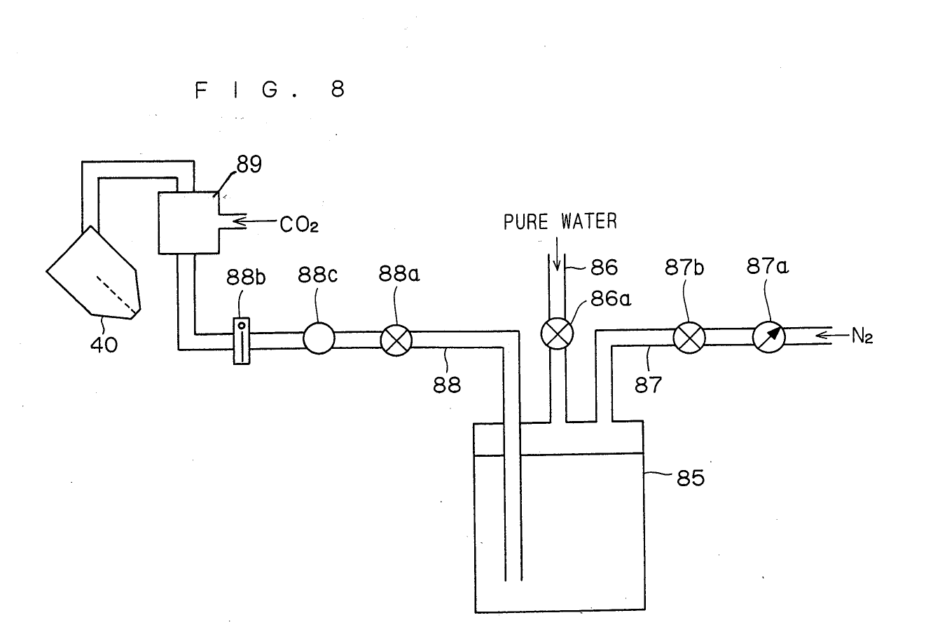

This substrate processing apparatus includes a wafer holding/rotating mechanism 10, a developer supply nozzle 20, a developer supply system (see FIG. 7), a developer supply nozzle scanning mechanism 30, a developer supply nozzle up-and-down mechanism 39, a processing solution supply nozzle 40, a processing solution supply system (see FIG. 8), a processing solution supply nozzle pivoting mechanism 50, a processing solution supply nozzle up-and-down mechanism 56 and final rinse water supply nozzles 70.

The wafer holding/rotating mechanism 10 is a mechanism for holding the semiconductor wafer SW almost in a horizontal position as well as rotating the semiconductor wafer SW, and has a support shaft 11, a spin chuck 12 provided on the upper end of the support shaft 11 and a spin motor 13 with a rotary shaft connected to the lower end of the support shaft 11.

The spin chuck 12 is intended to hold the semiconductor wafer SW almost in a horizontal position, and is constructed from a vacuum chuck for holding the semiconductor wafer SW by suction. Alternatively, a mechanical chuck for holding the semiconductor wafer SW by its outer periphery may be employed as the spin chuck 12.

The spin motor 13 is constructed from, for example, a servomotor, which is configured such that the rotation speed and the amount of rotation can be controlled variably in response to a signal (e.g., a pulse number signal) sent from a control section 60 which will be described later. The rotation of the spin motor 13 is transferred to the spin chuck 12 through the support shaft 11. The rotation driving of the spin motor 13 allows the semiconductor wafer SW to rotate within a horizontal plane about the vertical axis.

An inner cup 16 of substantially circular shape in plan view is provided around the spin chuck 12 so as to surround the semiconductor wafer SW held by the spin chuck 12. The inner cup 16 has an opening on its top side which gradually narrows in an upward direction, and is movable up and down by the action of an up-and-down mechanism such as an air cylinder such that the upper edge of the opening is moved between an up position defined around the outer periphery of the semiconductor wafer SW and a down position lower than the up position.

Further, an outer cup 17 of substantially rectangular shape in plan view is provided to surround the inner cup 16. When supplying a developer or processing solution from the developer supply nozzle 20 or processing solution supply nozzle 40 onto the semiconductor wafer SW, the developer or processing solution as supplied off the semiconductor wafer SW is intended to flow down on the outer surface of the inner cup 16 or between the inner cup 16 and outer cup 17 to be guided toward the bottom of the outer cup 17.

Furthermore, a waiting pot 18 is provided on one side outside the outer cup 17 in correspondence with a waiting position of the developer supply nozzle 20. The waiting pot 18 is formed like a case with such an opening on its top side that the developer supply nozzle 20 can be housed from above.

The developer supply nozzle 20 has a discharge port 22 for discharging the developer in a discharge width substantially equal to or greater than the width (diameter) of the semiconductor wafer SW.

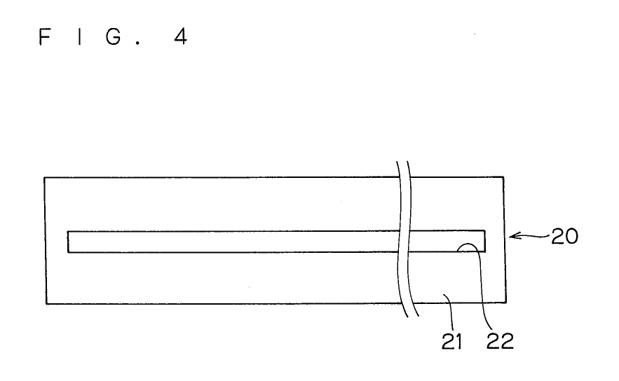

FIG. 4 shows the discharge port 22 provided for the developer supply nozzle 20. As shown, the developer supply nozzle 20 has the slit-like discharge port 22 on one side face of a long nozzle body 21. The discharge port 22 extends along the length of the nozzle body 21. The developer is discharged uniformly like a curtain from the discharge port 22 throughout its whole width to be supplied onto the semiconductor wafer SW throughout its whole width.

In addition, a developer supply system is connected to this developer supply nozzle 20. This developer supply system will be discussed later.

Referring back to FIGS. 1 to 3, the developer supply nozzle scanning mechanism 30 is a mechanism for moving the developer supply nozzle 20 horizontally so as to pass over the semiconductor wafer SW, and has a pair of support side plates 31a, 31b on both sides of a support member 5 guide-supported slidably in a horizontal direction and a horizontal driving section 35 for moving the support side plate 31a on the one side back and forth in the horizontal direction.

The support side plate 31a on the one side is a long plate. The lower portion of the support side plate 31a is guide-supported by two linear guides 32 provided on the outer surface of the one side wall of the support member 5 so as to be slidable in the horizontal direction while the upper portion of the support side plate 31a extends upwardly with respect to the support member 5.

The horizontal driving section 35 has a driving pulley 36 and a follower pulley 37 provided on the respective ends of the one side wall of the support member 5, a developer supply nozzle scanning motor 36a for rotating the driving pulley 36 and a belt 38 wound around these pulleys 36 and 37. The lower end of the support side plate 31a is fixed on the upper portion of the belt 38 running between the pulleys 36 and 37. Rotating the driving pulley 36 by driving the developer supply nozzle scanning motor 36a, the belt 38 rotates, and with the rotation of the belt 38, the support side plate 31a moves back and forth in the horizontal direction on the one side of the support member 5. The developer supply nozzle scanning motor 36a is constructed from a stepping motor, for example, which is configured such that the amount of rotation in both forward and reverse directions and the rotation speed can be controlled in response to a signal (e.g., a pulse number signal) sent from the control section 60.

A plurality of position sensors 34a, 34b, 34c and 34d for detecting shifted positions of the support side plate 31a to thereby detect shifted positions of the developer supply nozzle 20 are provided on the outer surface of the one side wall of the support member 5. The position sensor 34a for detecting a processing solution supply position U1, the position sensor 34b for detecting a waiting position U2, the position sensor 34c for detecting a developer discharge start position U3 and the position sensor 34d for detecting a developer discharge stop position U4 are arranged in this order from the right side of FIG. 2. A sector 31e attached to the support side plate 31a is inserted into the respective position sensors 34a to 34d, so that the positions U1 to U4 are detected respectively.

The support side plate 31b on the other side is also a long plate. A guide rail 33 is fixed on another support member different from the support member 5. The lower end of the support side plate 31b is supported so as to be movable back and forth in the horizontal direction along the guide rail 33 with a cam follower 33a interposed therebetween while the upper portion of the support side plate 31b extends upwardly with respect to the support member 5. When the developer supply nozzle 20 is in an up position, the cam follower 33a and guide rail 33 are spaced apart from each other.

The developer supply nozzle 20 is fixedly supported in a manner straddling the upper ends of the support side plates 31a and 31b. The developer supply nozzle 20 is arranged almost in a horizontal position with the discharge port 22 directed downwardly such that the developer is discharged in a nearly directly downward direction. A bridge member 31c for reinforcement is provided on one side of the developer supply nozzle 20 in a manner straddling the upper ends of the support side plates 31a and 31b. It is preferable that the both support side plates 31a, 31b and bridge member 31c be formed integrally by molding or the like.

Driving of the developer supply nozzle scanning mechanism 30 allows the developer supply nozzle 20 to pass over the semiconductor wafer SW, and while passing, the developer is discharged from the discharge port 22 so as to be supplied onto the main surface of the semiconductor wafer SW.

The support side plate 31b on the other side and the guide rail 33 for supporting the support side plate 31b may be omitted, and the developer supply nozzle 20 may be cantilevered.

The developer supply nozzle up-and-down mechanism 39 is a mechanism for moving the developer supply nozzle 20 up and down between a first position which allows the developer supply nozzle 20 to pass over the semiconductor wafer SW and a second position lower than the first position where the developer supply nozzle 20 can be housed in the waiting pot 18, and has an air cylinder 39a and a developer supply nozzle up-and-down guide 39b.

The developer supply nozzle up-and-down guide 39b guides the support member 5 so as to be movable up and down, and the air cylinder 39a moves the support member 5 up and down. The up-and-down of the support member 5 allows the respective components attached to the support member 5, that is, the developer supply nozzle 20, developer supply nozzle scanning mechanism 30, processing solution supply nozzle 40 and processing solution supply nozzle pivoting mechanism 50 to move up and down. The above-mentioned wafer holding/rotating mechanism 10, inner cup 16, outer cup 17 and waiting pot 18 are supported by another support member different from the support member 5. Therefore, the developer supply nozzle 20 and processing solution supply nozzle 40 move up and down relative to the semiconductor wafer SW held by the wafer holding/rotating mechanism 10.

In place of the air cylinder 39a, a servomotor and a ball screw mechanism may be employed. In that case, there is an advantage that the height of the developer supply nozzle 20 can be adjusted freely.

The developer supply nozzle scanning mechanism 30 and developer supply nozzle up-and-down mechanism 39 constitute a moving mechanism for moving the developer supply nozzle 20.

The processing solution supply nozzle 40 has a discharge port 42 for discharging the anti-static processing solution for preventing charging of the semiconductor wafer SW as well as stopping a development reaction in a discharge width substantially equal to or greater than the width (diameter) of the semiconductor wafer SW.

The processing solution supply nozzle 40 has the slit-like discharge port 42 on one side of a long nozzle body 41, similarly to the developer supply nozzle 20. The discharge port 42 extends along the length of the nozzle body 41. The anti-static processing solution is discharged uniformly like a curtain from the discharge port 42 throughout its whole width to be supplied onto the semiconductor wafer SW throughout its whole width.

Then, as will be described later, the processing solution supply nozzle 40 passes over the semiconductor wafer SW, so that the anti-static processing solution is supplied onto the semiconductor wafer SW. The developer on the semiconductor wafer SW is diluted with the anti-static processing solution into such a concentration that the development reaction is stopped or below such concentration, or the developer is replaced by the anti-static processing solution, so that the development reaction on the semiconductor wafer SW is stopped.

In addition, a processing solution supply system for supplying the anti-static processing solution is connected to this processing solution supply nozzle 40. This processing solution supply system will be discussed later.

The processing solution supply nozzle pivoting mechanism 50 is a mechanism for pivoting the processing solution supply nozzle 40 so as to pass over the semiconductor wafer SW, and has a processing solution supply nozzle pivoting motor 52 and a rotary shaft 54.

The processing solution supply nozzle pivoting motor 52 is constructed from a stepping motor and the like, and is attached to a position close to one end of the developer supply nozzle 20 with a bracket 51 and the processing solution supply nozzle up-and-down mechanism 56 interposed therebetween. The rotation speed and the amount of rotation of the motor 52 are controlled variably in response to a signal (e.g., a pulse number signal) sent from the control section 60.

The rotary shaft 54 is connected to a motor shaft of the processing solution supply nozzle pivoting motor 52, and extends downwardly from the bottom surface of the bracket 51. The rotary shaft 54 is configured to be rotatable about a vertex of an imaginary square S circumscribed with the outer edge of the semiconductor wafer SW held by the wafer holding/rotating mechanism 10 when the developer supply nozzle 20 is in the processing solution supply position U1.

One end of the processing solution supply nozzle 40 is fixedly connected to the lower end of the rotary shaft 54, so that the processing solution supply nozzle 40 is cantilevered almost in a horizontal position above the support member 5. The discharge port 42 of the processing solution supply nozzle 40 is designed to incline at an angle ranging from 15 to 16 degrees, for example, with respect to a horizontal plane in a reverse direction to a direction in which the processing solution supply nozzle 40 pivots while discharging the processing solution. The reason for such inclination is to prevent the anti-static processing solution from flowing out prior to the movement of the processing solution supply nozzle 40. The rotation of the rotary shaft 54 by the driving of the processing solution supply nozzle pivoting motor 52 allows the processing solution supply nozzle 40 to pivot so as to pass over the semiconductor wafer SW. The processing solution supply nozzle 40 discharges the anti-static processing solution from the discharge port 42 while passing over the semiconductor wafer SW, so that the anti-static processing solution is supplied onto the main surface of the semiconductor wafer SW.

The processing solution supply nozzle 40 is attached to the bridge member 31c with the bracket 51, processing solution supply nozzle pivoting motor 52, processing solution supply nozzle up-and-down mechanism 56 and a cylinder-attaching bracket 31d which will be described later interposed therebetween.

A processing solution supply nozzle original position sensor 55b is attached to the bracket 51 with a sensor bracket 55a interposed therebetween. A sector 41a serving as a detected member is fixed to the nozzle body 41 of the processing solution supply nozzle 40. The sector 41a is inserted into the sensor 55b with the processing solution supply nozzle 40 placed in an original position (here, a position substantially parallel to the developer supply nozzle 20). The sensor 55b thereby detects whether or not the processing solution supply nozzle 40 is placed in the original position.

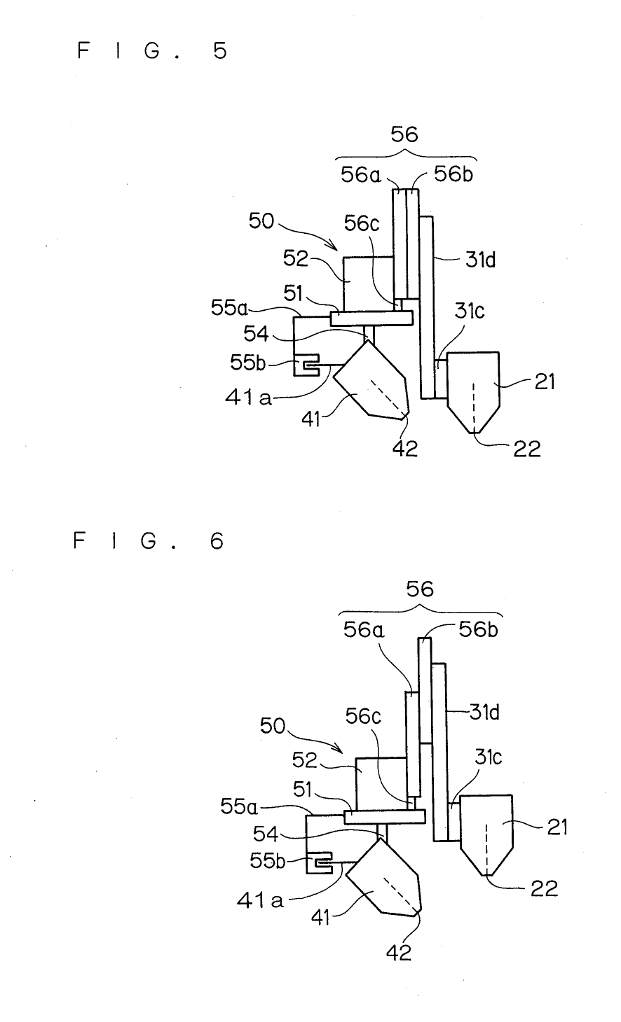

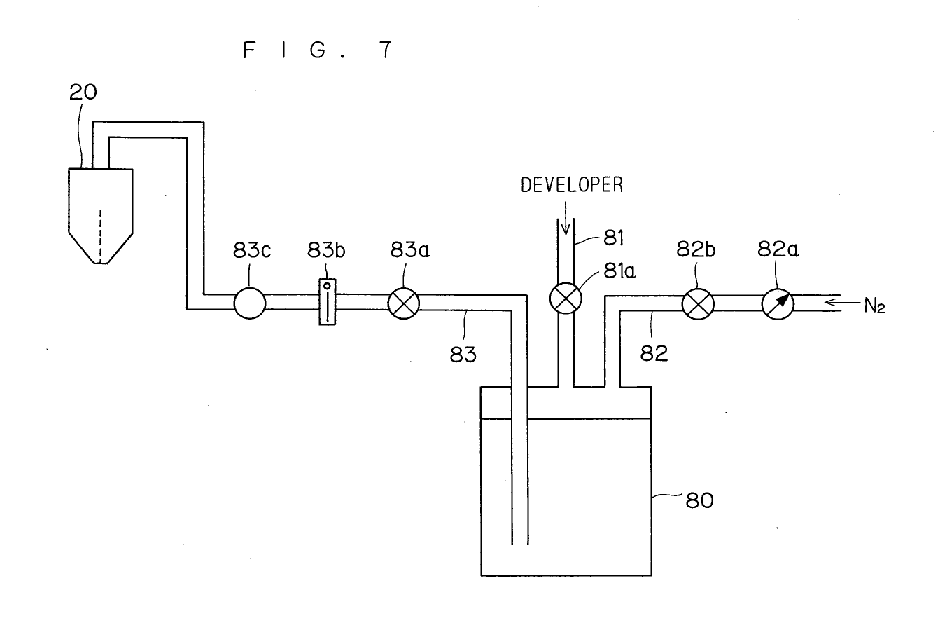

FIGS. 5 and 6 are enlarged views of an essential part showing the developer supply nozzle 20 and processing solution supply nozzle 40. FIG. 5 shows the processing solution supply nozzle 40 in an up position, and FIG. 6 shows the processing solution supply nozzle 40 in a down position.

More specifically, the processing solution supply nozzle up-and-down mechanism 56 has block members 56a and 56b connected to be slidable up and down relative to each other. The block member 56a is fixed on the side of the bracket 51 with a rod 56c interposed therebetween, and the block member 56b fixed on the side of the bridge member 31c with the cylinder-attaching bracket 31d interposed therebetween. The block member 56a is arranged to be slidable relative to the other block member 56b by air driving, for example. Accordingly, the up-and-down of the bracket 51 allows the processing solution supply nozzle 40 to move up and down together with the processing solution supply nozzle pivoting motor 52 and the like relative to the developer supply nozzle 20.

In the present embodiment, the processing solution supply nozzle 40 is attached integrally to the developer supply nozzle 20, however, these nozzles may be provided separately.

Referring back to FIGS. 1 to 3, the two final rinse water supply nozzles 70 are provided one each on the leading edge of a nozzle support arm 71 and on a relatively backward side of the leading edge. A rinse water is supplied to each of the final rinse water supply nozzles 70 through a pipe 72.

As the rinse water to be supplied, an anti-static processing solution similar to that supplied from the above-described processing solution supply nozzle 40 or pure water may be employed. The use of pure water results in savings of chemical solution.

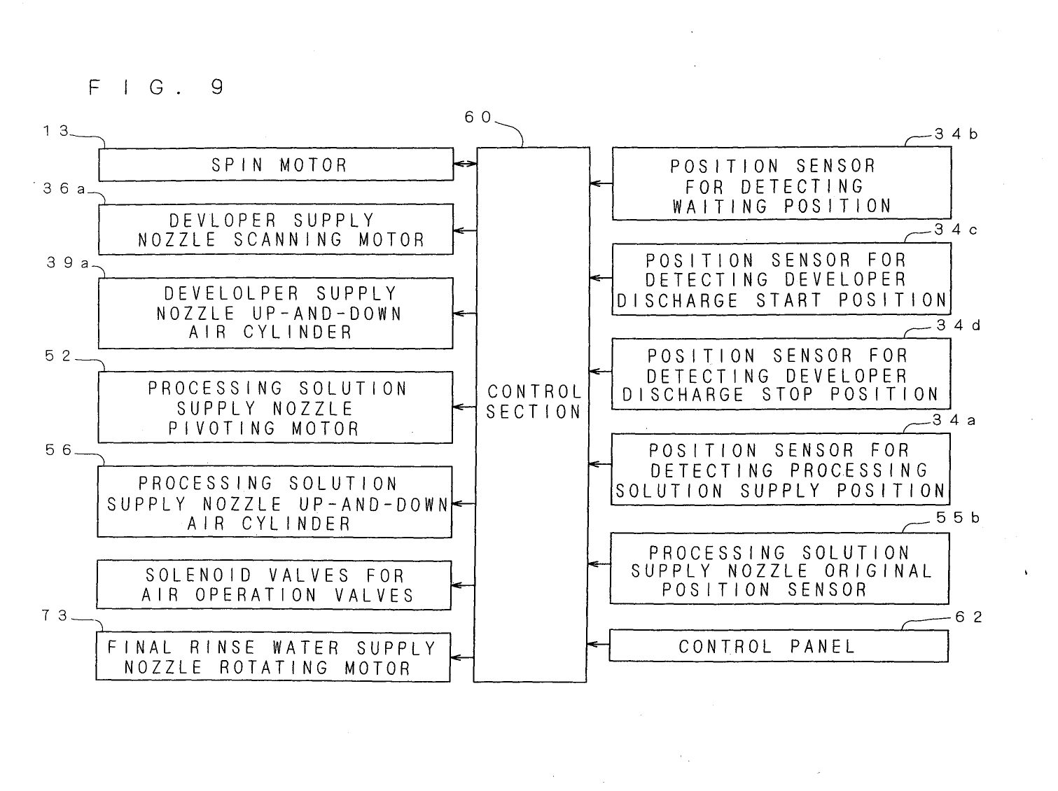

One of the final rinse water supply nozzles 70 on the leading edge is intended to supply the rinse water onto the central portion of the semiconductor wafer SW, and the other one of the final rinse water supply nozzles 70 provided on a relatively backward side is intended to supply the rinse water onto the peripheral portion of the semiconductor wafer SW. One end of the nozzle support arm 71 is attached pivotably in an area surrounding the semiconductor wafer SW, more specifically, in a position farther than the processing solution supply position U1 from the semiconductor wafer SW. When supplying the developer or anti-static processing solution onto the semiconductor wafer SW, the nozzle support arm 71 is placed in a waiting position away from the semiconductor wafer SW in a lateral direction (see FIG. 1). When cleaning the main surface of the semiconductor wafer SW after the anti-static processing solution is supplied onto the semiconductor wafer SW, a nozzle rotating mechanism including a final rinse water supply nozzle rotating motor 73 (see FIG. 9) is driven to cause the nozzle support arm 71 to pivot such that the final rinse water supply nozzle 70 on the leading edge is placed above the semiconductor wafer SW, and then, the rinse water is discharged from the final rinse water supply nozzles 70 onto the central portion and peripheral portion of the semiconductor wafer SW.

FIG. 7 is a piping diagram showing the developer supply system.

The developer supply system includes a developer tank 80 for applying pressure, a first developer pipe 81 for connecting the developer tank 80 and another developer tank or a plant utility system serving as a predetermined developer source installed in a plant, a second developer pipe 82 for connecting a predetermined N₂ gas source and the developer tank 80 and a third developer pipe 83 for connecting the developer tank 80 and developer supply nozzle 20. An air operation valve 81a is provided halfway in the first developer pipe 81. A regulator 82a for controlling the flow rate of N₂ gas and an air operation valve 82b are provided halfway in the second developer pipe 82. An air operation valve 83a, a flow meter 83b having a mechanism for measuring and controlling the flow rate of the developer flowing toward the developer supply nozzle 20, and a filter 83c for removing foreign substances included in the developer are provided halfway in the third developer pipe 83. Each one end of the first and second developer pipes 81 and 82 close to the developer tank 80 is open into an upper space of the developer tank 80 where the developer is not present. One end of the third developer pipe 83 close to the developer tank 80 extends toward the bottom of the developer tank 80, with its opening immersed in the developer as stored. The opening and closing of the air operation valves 81a, 82b and 83a is controlled by controlling the flow rate of gas such as N₂ gas, and the flow rate of gas for the open/close control is controlled by opening and closing a solenoid valve by the control section 60.

For supplying the developer to the developer supply nozzle 20, the developer is previously supplied into the developer tank 80. When supplying the developer into the developer tank 80, the air operation valve 81a is opened with the air operation valves 82b and 83a closed, so that the developer is supplied into the developer tank 80 through the first developer pipe 81. Then, the developer is sufficiently stored in the developer tank 80. When supplying the developer to the developer supply nozzle 20, the air operation valves 82b and 83a are opened with the air operation valve 81a closed. The N₂ gas is guided into the developer tank 80 through the second developer pipe 82, which increases an internal pressure of the developer tank 80. The developer is pumped up under this internal pressure to be supplied to the developer supply nozzle 20 through the third developer pipe 83. The flow rate of the developer supplied to the developer supply nozzle 20 through the third developer pipe 83 is controlled by the flow meter 83b.

FIG. 8 is a piping diagram showing the processing solution supply system.

The processing solution supply system includes a processing solution tank 85 for applying pressure, a first processing solution pipe 86 for connecting the processing solution tank 85 and another solution storage tank or a plant utility system serving as a predetermined pure water source installed in a plant, a second processing solution pipe 87 for connecting a predetermined N₂ gas source and the processing solution tank 85 and a third processing solution pipe 88 for connecting the processing solution tank 85 and processing solution supply nozzle 40. An air operation valve 86a is provided halfway in the first processing solution pipe 86. A regulator 87a and an air operation valve 87b are provided halfway in the second processing solution pipe 87. An air operation valve 88a, a filter 88c for removing foreign substances included in the processing solution, and a flow meter 88b having a mechanism for measuring and controlling the flow rate of the processing solution flowing toward the processing solution supply nozzle 40 are provided halfway in the third processing solution pipe 88.

In short, the processing solution supply system has a similar construction to the above-described developer supply system except that the filter 88c and flow meter 88b are interchanged in position in the third processing solution pipe 88 and that a gas dissolving section 89 which will be described next is added, and supplies the anti-static processing solution to the processing solution supply nozzle 40 on similar operating principles.

The gas dissolving section 89 is provided halfway in the third processing solution pipe 88, here, between the flow meter 88b and processing solution supply nozzle 40. CO₂ gas is supplied from a CO₂ gas source not shown to this gas dissolving section 89, where the supplied CO₂ gas is dissolved in pure water. For such gas dissolving section 89, a structure for dissolving CO₂ gas in pure water using a diaphragm which does not pass water molecules but pass gas molecules only, a structure for dissolving CO₂ gas in pure water by spraying pure water into an atmosphere of CO₂ gas by an ultrasonic nozzle or the like may be employed.

As described, an aqueous CO₂ solution obtained by dissolving CO₂ gas in pure water, in which hydrogen ions and hydrogen carbonate ions are dissociated, has a small electrical resistivity. Therefore, such aqueous CO₂ solution, when supplied onto a substrate, serves as an anti-static processing solution for avoiding charging of the substrate.

For such anti-static processing solution, the above-described aqueous CO₂ solution or various types of processing solutions in which ions are dissociated in such a degree that charging of the substrate can be avoided may be employed.

FIG. 9 is a block diagram showing an electrical configuration of the substrate processing apparatus according to the present embodiment.

The control section 60 controls a series of operations which will be discussed later, and is constructed from a general microcomputer having CPU, ROM, RAM and the like for performing a predetermined computing operation under a previously stored software program.

To this control section 60, the position sensors 34a to 34d for detecting shifted positions of the developer supply nozzle 20 and the processing solution supply nozzle original position sensor 55b are connected, so that respective detecting signals are input to the control section 60. Further, a control panel 62 is connected to the control section 60, so that a predetermined operating instruction is input to the control section 60 through the control panel 62.

The spin motor 13 constructed from a servomotor and the like is also connected to the control section 60. The control section 60 receives a detecting signal output from a rotation amount detecting mechanism and the like such as a rotary encoder on the side of the spin motor 13, and performs feedback control on the amount of rotation of the spin motor 13 based on the detecting signal.

Further, the developer supply nozzle scanning motor 36a, air cylinder 39a for moving the developer supply nozzle 20 up and down, processing solution supply nozzle pivoting motor 52, processing solution supply nozzle up-and-down mechanism (air cylinder) 56, final rinse water supply nozzle rotating motor 73, respective solenoid valves for the air operation valves 81a, 82b, 83a, 86a, 87b and 88a in the above-described developer supply system and processing solution supply system are also connected to the control section 60, and their operations are controlled by the control section 60.

Next, a developing operation of the semiconductor wafer SW by this substrate processing apparatus will be discussed.

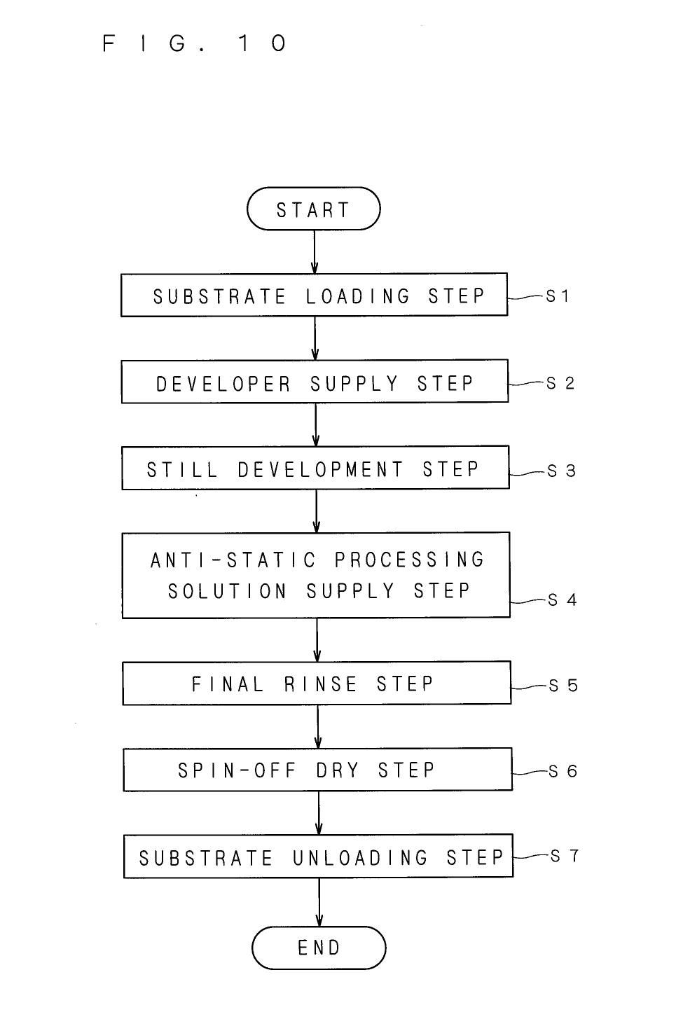

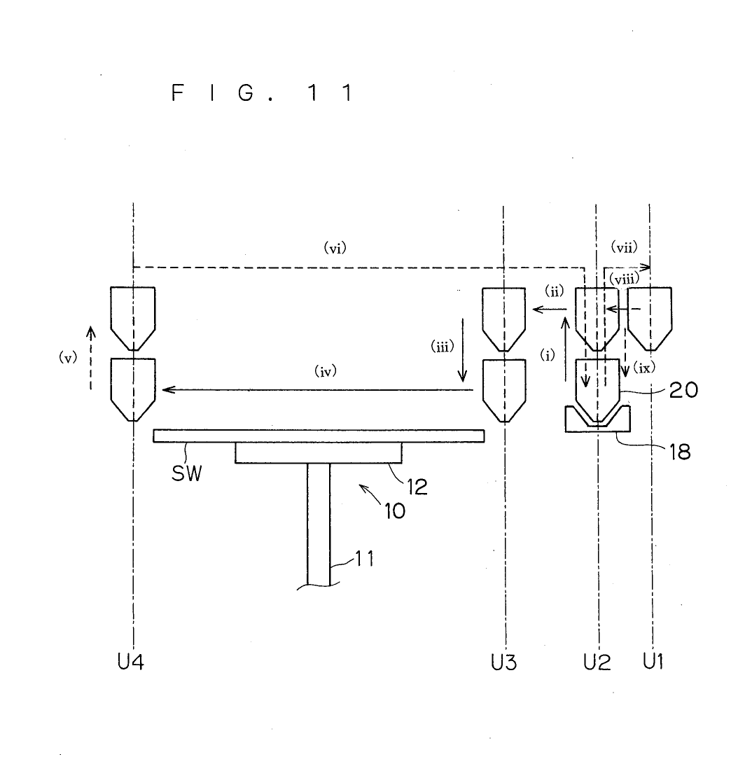

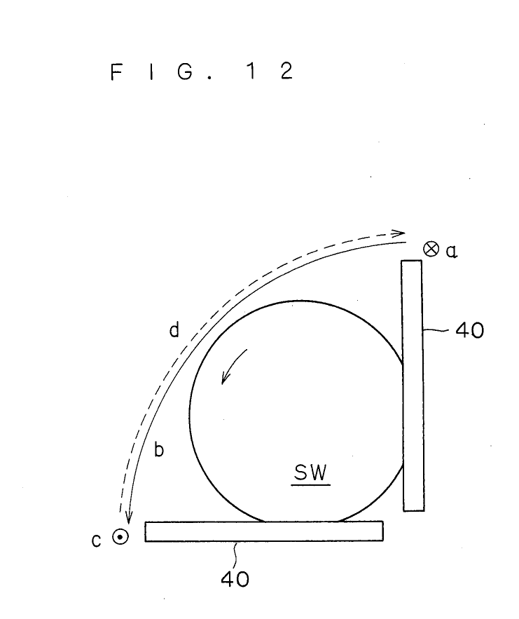

FIG. 10 is a flow chart showing a series of steps of developing operation performed by the substrate processing apparatus. FIG. 11 is an explanatory view showing a movement of the developer supply nozzle 20, and FIG. 12 is an explanatory view showing a movement of the processing solution supply nozzle 40.

After the start of the operation, in step S1, the semiconductor wafer SW is first loaded onto the spin chuck 12 of the wafer holding/rotating mechanism 10 by a transfer robot. In an initial state, the inner cup 16 is in the down position.

Next, in step S2, the developer is supplied onto the semiconductor wafer SW.

More specifically, as shown in FIG. 11, in the initial state, the developer, supply nozzle 20 is housed within the waiting pot 18 in the waiting position U2. Then, after the start of step S2, the developer supply nozzle 20 moves up in the waiting position U2 as indicated by an arrow (i) to go away from the waiting pot 18. Subsequently, as indicated by an arrow (ii), the developer supply nozzle 20 moves horizontally at a constant speed toward the developer discharge start position U3 at one end of the semiconductor wafer SW, and then moves down in the position U3 as indicated by an arrow (iii) to start discharging the developer. Here, one end of the semiconductor wafer SW is in an arbitrary position on the periphery of the semiconductor wafer SW, and the opposite end is in a position facing the one end with respect to the center of the semiconductor wafer SW. Next, as indicated by an arrow (iv), the developer supply nozzle 20 supplies the developer onto the semiconductor wafer SW in a constant flow rate while moving horizontally at a constant speed from the position U3 toward the developer discharge stop position U4 on the other end of the semiconductor wafer SW. The developer thereby accumulates on the semiconductor wafer SW.

Next, as indicated by an arrow (v), the developer supply nozzle 20 moves up in the position U4.

In step S2, the processing solution supply nozzle 40 is in the up position, and moves along with the developer supply nozzle 20. The semiconductor wafer SW remains at rest.

Next, in step S3, a still developing operation is conducted.

More specifically, the developing operation is conducted on the semiconductor wafer SW having undergone exposure with the semiconductor wafer SW held stationary. A time period of this still developing operation depends on the speed of dissolution of resist and a throughput of the apparatus, and is set within a range between 3 and 120 seconds.

After this still developing operation is finished, the developer supply nozzle 20 once returns to the waiting position U2 to move down into the waiting pot 18, as indicated by an arrow (vi). In a structure where the processing solution supply nozzle 40 and developer supply nozzle 20 are provided separately, the developer supply nozzle 20 may be designed to return to the waiting position U2 after a substrate unloading step (step S7) which will be described later, in other words, after the semiconductor wafer SW is taken out.

Next, as shown in step S4, the anti-static processing solution is supplied onto the semiconductor wafer SW.

First, as indicated by an arrow (vii), the developer supply nozzle 20 moves up, and moves toward the processing solution supply position U1 away from the semiconductor wafer SW. The developer supply nozzle 20 remains at still in the up position. At this time, the processing solution supply nozzle 40 is positioned above one end of the semiconductor wafer SW. This position is slightly closer to the semiconductor wafer SW than the position where the developer supply nozzle 20 starts discharging the developer.

In this state, as indicated by an arrow a in FIG. 12, the processing solution supply nozzle 40 moves down relative to the developer supply nozzle 20. Next, the discharge of the anti-static processing solution from the processing solution supply nozzle 40 is started. After the start of the discharge of the anti-static processing solution, a pivot of the processing solution supply nozzle 40 is started, and at the same time, a rotation of the semiconductor wafer SW is started. In a circumferential direction of the semiconductor wafer SW, the position where the processing solution is supplied and that where the developer is supplied are substantially the same. Then, the processing solution supply nozzle 40 is pivoted by π/2 rad (90 degrees) (see an arrow b in FIG. 12), and at the same time, the semiconductor wafer SW is rotated by π/2 rad (90 degrees).

At this time, assuming that a line connecting the supply start point on the semiconductor wafer SW where the supply of the processing solution is started and the supply finish point on the semiconductor wafer SW on the opposite side of the supply start point with respect to the center of the semiconductor wafer SW extends in an imaginary scanning direction, it is preferable that the imaginary scanning direction and the extending direction of the processing solution supply nozzle 40 be orthogonal to each other to the extent possible.

Further, it is preferable that a component of velocity of the processing solution supply nozzle 40 on the semiconductor wafer SW in the imaginary scanning direction and a speed of the developer supply nozzle 20 be as equal to each other as possible.

To satisfy these two relationships to the extent possible, the rotation speed of the processing solution supply nozzle 40 and that of the semiconductor wafer SW are controlled as appropriate.

In this case, it is not necessary to spin the semiconductor wafer SW such that the rinse water supplied on the central portion of the semiconductor wafer SW is spread out over the wafer as in the conventional case. Therefore, the semiconductor wafer SW rotates at such low speeds that rotation does not cause excessive charging of the semiconductor wafer SW.

The anti-static processing solution is supplied onto the semiconductor wafer SW as described above, so that the development reaction on the semiconductor wafer SW is stopped.

Then, after pivoting over the semiconductor wafer SW, the processing solution supply nozzle 40 moves up relative to the developer supply nozzle 20 as indicated by an arrow c in FIG. 12, and returns to its original position in a reverse direction to the arrow b, as indicated by an arrow d. Then, as indicated by arrows (viii) and (ix), the developer supply nozzle 20 moves to the waiting position U2 and is housed within the waiting pot 18.

Next, in step S5, rinse water is finally supplied onto the semiconductor wafer SW.

More specifically, the inner cup 16 is moved up, and the rinse water (pure water) is supplied from the final rinse water supply nozzles 70 onto the semiconductor wafer SW while rotating the semiconductor wafer SW, so that development products are removed by cleaning.

The revolution per minute of the semiconductor wafer SW at this time ranges from 500 rpm to 1000 rpm, for example.

Next, in step S6, the semiconductor wafer SW is spun, so that the rinse water on the semiconductor wafer SW is spun off and dried.

The revolution per minute of the semiconductor wafer SW at this time ranges from 1500 rpm to 3000 rpm, for example.

Finally, in step S7, the inner cup 16 is moved down, and the holding of the semiconductor wafer SW by the spin chuck 12 by suction is released. Thereafter, the semiconductor wafer SW is unloaded by the transport robot.

According to the substrate processing apparatus having the above-described construction, the processing solution supply nozzle 40 having the discharge port 42 for discharging the anti-static processing solution in a predetermined discharge width passes over the semiconductor wafer SW, so that the anti-static processing solution is supplied almost uniformly onto the entire surface of the semiconductor wafer SW.

At this time, it is not necessary to spin the semiconductor wafer SW to spread the processing solution across the semiconductor wafer SW as in the conventional case, which can avoid charging of the semiconductor wafer SW. Further, the anti-static processing solution such as aqueous CO₂ solution supplied onto the semiconductor wafer SW can cancel charging occurred a little on the semiconductor wafer SW. Therefore, it is possible to achieve an improved effect of avoiding charging of the semiconductor wafer SW as well as to avoid the occurrence of post-develop defects.

Further, moving the slit-like discharge port 42 over the semiconductor wafer SW, a development stop liquid is supplied onto the semiconductor wafer SW, so that the concentration of the developer on the semiconductor wafer SW shows a relatively gentle change, causing the development reaction to stop gradually. This can avoid the occurrence of defects due to a rapid neutralization.

Furthermore, the anti-static processing solution is supplied almost uniformly on the entire surface of the semiconductor wafer SW by the processing solution supply nozzle 40 having the discharge port 42 of a predetermined discharge width, which can reduce an area where the anti-static processing solution is not supplied to a minimum. The occurrence of post-develop defects can be avoided for this reason as well.

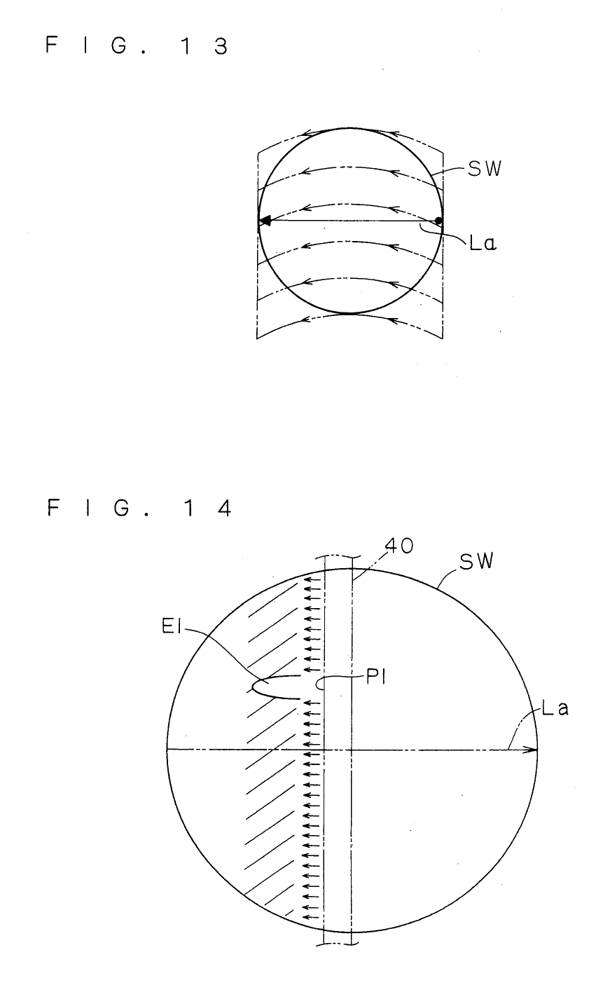

Still further, according to the substrate processing apparatus, as shown in FIG. 13, the processing solution supply nozzle 40 moves over the semiconductor wafer SW in an imaginary scanning direction La non-linearly (for example, arcuately). Therefore, the anti-static processing solution can be supplied uniformly on the entire surface of the semiconductor wafer SW.

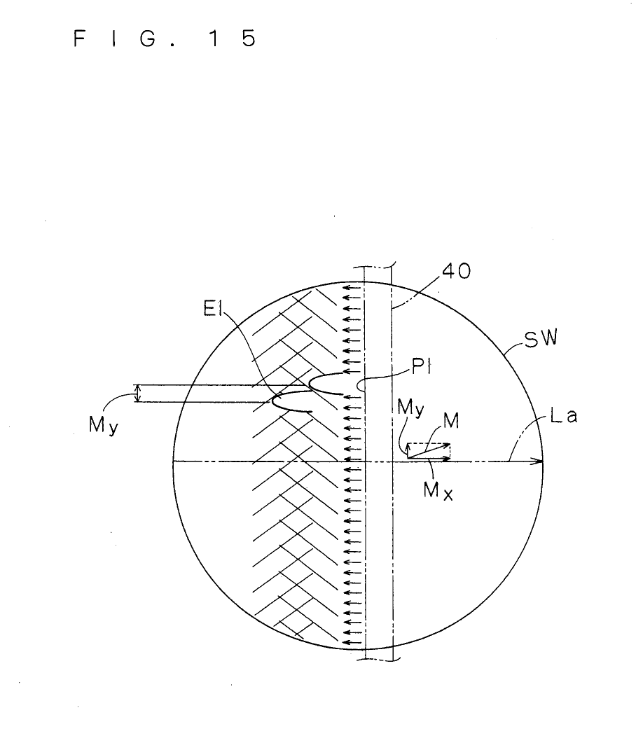

Detailed description will be given now in reference to FIGS. 14 and 15. FIGS. 14 and 15 each show a state of supplying the anti-static processing solution onto the semiconductor wafer SW with a point P1 from which the anti-static processing solution is not supplied present in a certain position in the extending direction of the processing solution supply nozzle 40. In each of FIGS. 14 and 15, an area diagonally shaded up to the right indicates an area to which the anti-static processing solution is supplied at the stage shown in FIG. 14. In FIG. 15, an area diagonally shaded up to the left indicates an area to which the processing solution is supplied at the stage shown in FIG. 15.

As shown in FIG. 14, considering a state where the processing solution supply nozzle 40 has moved halfway in the imaginary scanning direction La over the semiconductor wafer SW, an area E1 to which the processing solution is not supplied is present as a streak on the semiconductor wafer SW in a rear direction on the extension of the point P1.

Then, as shown in FIG. 15, the processing solution supply nozzle 40 moves over the semiconductor wafer SW arcuately, which means the processing solution supply nozzle 40 moves a distance Mx in the imaginary scanning direction La and a distance My in a direction substantially orthogonal to the imaginary scanning direction La. Therefore, the point P1 of the discharge port 42 also moves a distance My in the direction substantially orthogonal to the imaginary scanning direction La from the position shown in FIG. 14, so that a portion (other than the point P1) of the discharge port 42 that can supply the processing solution is placed in a position corresponding to the area E1. Then, in the state shown in FIG. 15, the processing solution discharged from the portion of the discharge port 42 that can supply the processing solution is supplied onto the area E1.

These operations are performed continuously as the processing solution supply nozzle 40 rotates and moves. Accordingly, it is possible to reduce an area where the anti-static processing solution is not supplied to zero. This achieves uniform development and avoids post-develop defects.

In the present embodiment, the method of finally supplying rinse water in the final rinse step (step S5) is not limited to the above-described one. For instance, similarly to the processing solution supply nozzle 40, a nozzle having a slit-like discharge port may be employed to supply the rinse water. Alternatively, the final rinse step (step S5) itself may be omitted.

### Second Preferred Embodiment

A substrate processing apparatus according to a second preferred embodiment of the present invention will be discussed. The description in this embodiment will be focused on differences from the first preferred embodiment, and similar components will be referred to using the same reference characters, repeated explanation of which is thus omitted here.

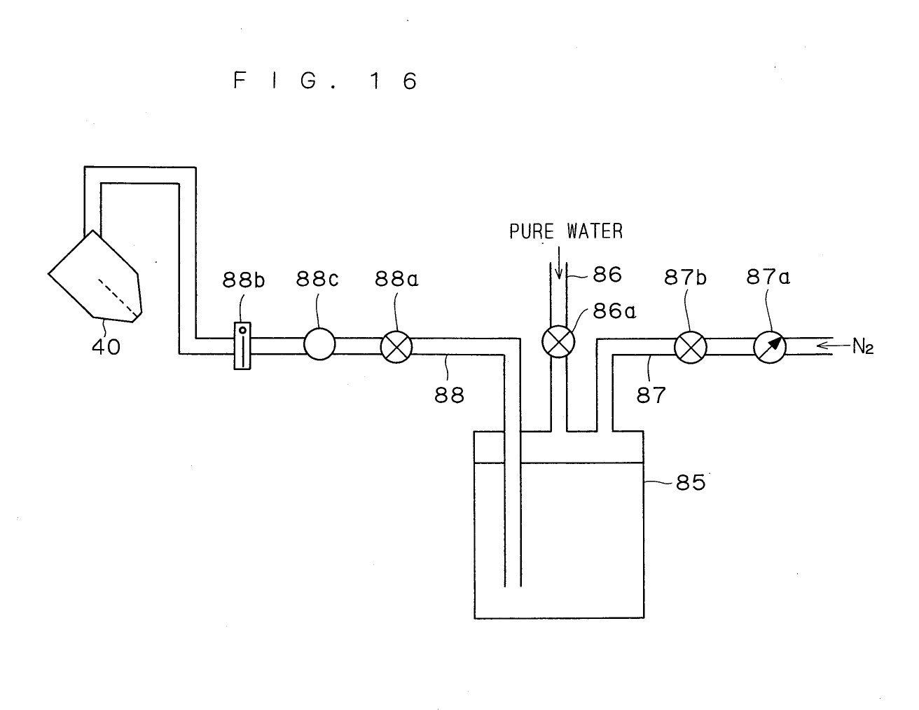

In the substrate processing apparatus according to the second preferred embodiment, a processing solution supply system shown in FIG. 16 is connected to the processing solution supply nozzle 40 in place of the processing solution supply system according to the first preferred embodiment shown in FIG. 8.

The processing solution supply system shown in FIG. 16 is a system for supplying a development stop liquid (e.g., pure water) for stopping a development reaction to the processing solution supply nozzle 40 as a first processing solution, and more specifically, has the same construction as that of the processing solution supply system shown in FIG. 8 although the gas dissolving section 89 is omitted.

Further, in the substrate processing apparatus, an anti-static cleaning solution supply system for supplying an anti-static cleaning solution as a second processing solution is connected to the final rinse water supply nozzles 70, serving as the second processing solution supply nozzles.

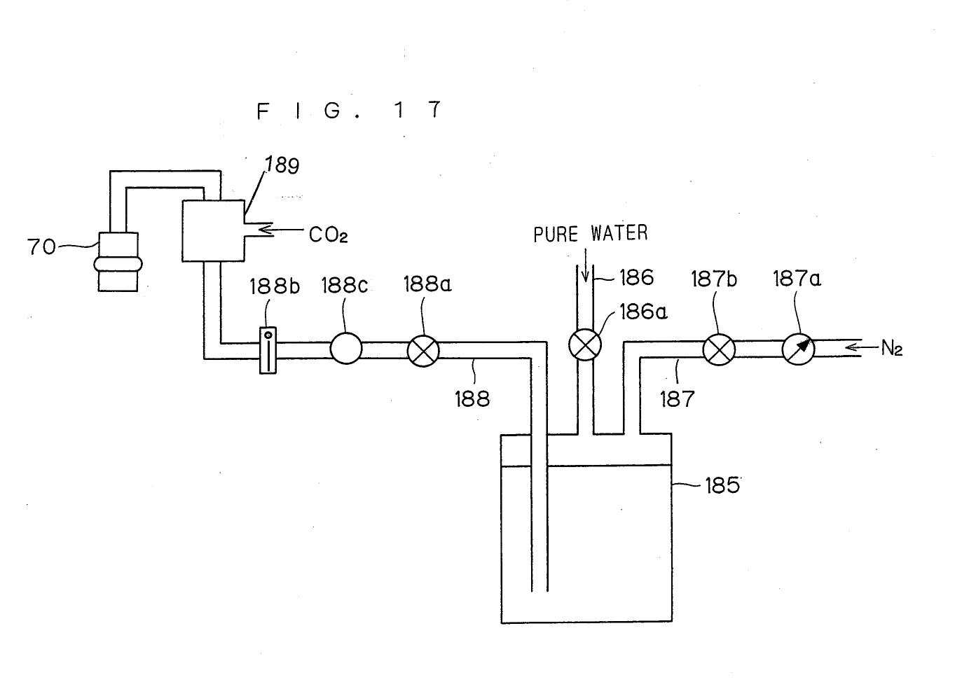

As shown in FIG. 17, this anti-static cleaning solution supply system has a processing solution tank 185 for applying pressure, a first anti-static cleaning solution pipe 186 for connecting the processing solution tank 185 and another solution storage tank or a plant utility system serving as a predetermined pure water source installed in a plant, a second anti-static cleaning solution pipe 187 for connecting a predetermined N₂ gas source and the processing solution tank 185 and a third anti-static cleaning solution pipe 188 for connecting the processing solution tank 185 and final rinse water supply nozzles 70. An air operation valve 186a is provided halfway in the first anti-static cleaning solution pipe 186. A regulator 187a and an air operation valve 187b for controlling the flow rate of N₂ gas are provided halfway in the second anti-static cleaning solution pipe 187. An air operation valve 188a, a filter 188c for removing foreign substances included in the anti-static cleaning solution, and a flow meter 188b having a mechanism for measuring and controlling the flow rate of the anti-static cleaning solution flowing toward the final rinse water supply nozzles 70 are provided halfway in the third anti-static cleaning solution pipe 188.

In short, the anti-static cleaning solution supply system has a similar construction to the processing solution supply system shown in FIG. 8, and supplies the anti-static cleaning solution to the final rinse water supply nozzles 70 on similar operating principles.

It is preferable that ions, i.e., CO₂ be dissolved in the anti-static cleaning solution supplied to the final rinse water supply nozzles 70 in such a concentration that no bubble is generated.

Next, a developing operation of the semiconductor wafer SW by this substrate processing apparatus will be discussed.

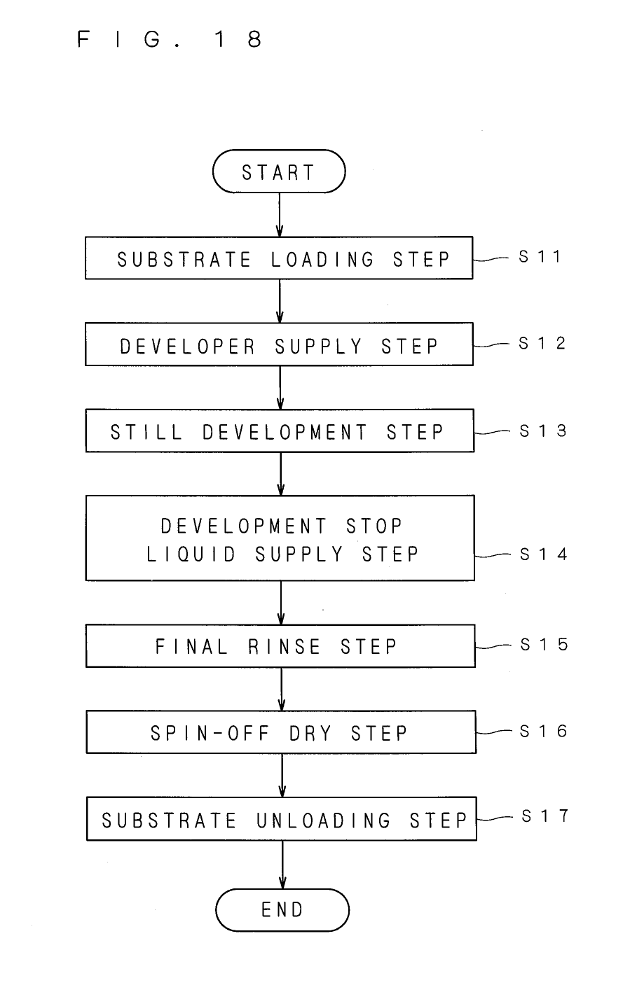

FIG. 18 is a flow chart showing a series of steps of developing operation performed by the substrate processing apparatus.

After the start of the operation, the semiconductor wafer SW is loaded (step S11; substrate loading step), and then, the developer is supplied onto the semiconductor wafer SW (step S12; developer supply step). Thereafter, a still developing operation is performed (step S13; still development step). The steps S11 to S13 are the same as steps S1 to S3 as described above.

When the still developing operation is completed after a lapse of a predetermined time period after the supply of the developer, the development stop liquid is supplied onto the semiconductor wafer SW in step S14.

More specifically, after the start of discharge of the development stop liquid from the processing solution supply nozzle 40, a rotation of the semiconductor wafer SW is started at the same time a pivot of the processing solution supply nozzle 40 is started.

Accordingly, the development stop liquid is supplied onto the semiconductor wafer SW in a similar manner of supplying the anti-static processing solution is supplied onto the semiconductor wafer SW as described in the first preferred embodiment. The development stop liquid supplied onto the semiconductor wafer SW as described stops the development reaction on the semiconductor wafer SW.

At this time, the developer is supplied from the processing solution supply nozzle 40 in such an amount and a manner that the developer on the semiconductor wafer SW can be brought into a predetermined concentration (such that the development reaction is stopped) or below such concentration. Accordingly, products by the developing operation and the like remain on the semiconductor wafer SW just after step S14.

Next, in step S15, rinse water is finally supplied onto the semiconductor wafer SW.

More specifically, the final rinse water supply nozzles 70 are moved above the semiconductor wafer SW, and the anti-static cleaning solution is supplied onto the semiconductor wafer SW from the final rinse water supply nozzles 70 while rotating the semiconductor wafer SW. Then, the anti-static cleaning solution is supplied in such an amount and a manner that the developer on the semiconductor wafer SW is replaced and removed by the anti-static cleaning solution and that development products are removed by cleaning.

The anti-static cleaning solution supplied onto the semiconductor wafer SW avoids frictional charging of the semiconductor wafer SW due to spinning even in the case of spinning the semiconductor wafer SW.

The operation of the processing solution supply nozzle 40 and the like in steps S14 and S15 are almost the same as the operations in steps S4 and S5 described in the first preferred embodiment.

Next, similarly to steps S6 and S7 as described above, in step S16, the semiconductor wafer SW is spun, so that the rinse water on the semiconductor wafer SW is spun off and dried. Finally, in step S17, the semiconductor wafer SW is unloaded by the transport robot.

According to the substrate processing apparatus and substrate processing method as above described, the anti-static cleaning solution is supplied onto the semiconductor wafer SW after the development stop liquid is supplied, which can prevent generation of reactants of the developer and anti-static cleaning solution. This can avoid the occurrence of defects.

Further, moving the slit-like discharge port 42 over the semiconductor wafer SW, a development stop liquid is supplied onto the semiconductor wafer SW, so that the concentration of the developer on the semiconductor wafer shows a relatively gentle change, causing the development reaction to stop gradually. This can avoid the occurrence of defects due to a rapid neutralization.

Furthermore, subsequently to the supply of the development stop liquid, the anti-static cleaning solution is supplied in order to remove and clean the developer and products on the semiconductor wafer SW, which avoids charging of the semiconductor wafer SW in the cleaning step after the stop of development. Therefore, it is possible to avoid the occurrence of post-develop defects resulting from adhesion of charged particles included in the solution on the semiconductor wafer SW to the surface of the semiconductor wafer SW.

Particularly, the use of a solution with ions such as carbonate ions dissolved therein as the anti-static cleaning solution in such a concentration that no bubble is generated can prevent pattern fall resulting from bubbles and the like.

In the present embodiment, the construction of supplying the anti-static cleaning solution is not limited to the above-described one. For instance, similarly to the processing solution supply nozzle 40, a nozzle having a slit-like discharge port may be used to supply the anti-static cleaning solution.

### Variant

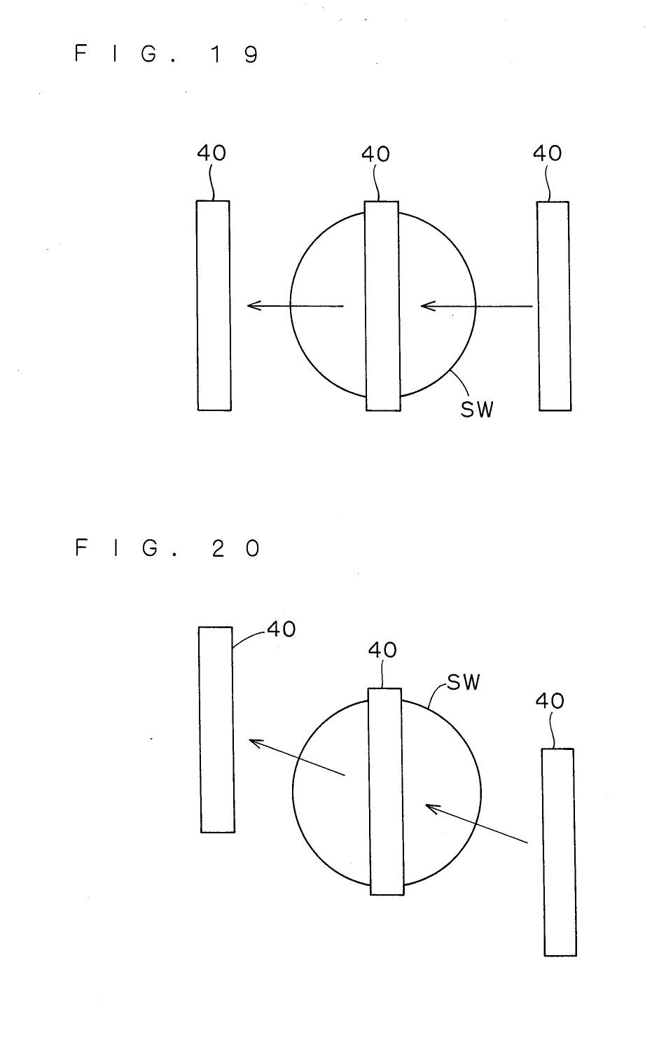

The above-described preferred embodiments have been directed to the case of rotating both the processing solution supply nozzle 40 and semiconductor wafer SW, however, as shown in FIG. 19, the processing solution supply nozzle 40 may be moved linearly from one end to the opposite end of the semiconductor wafer SW being held stationary.

Further, as shown in FIG. 20, the processing solution supply nozzle 40 may be moved linearly along a line tilted relative to a line connecting the one end and the opposite end of the semiconductor wafer SW being held stationary. In this case, the processing solution supply nozzle 40 is moved in such a position that the moving direction and extending direction of the processing solution supply nozzle 40 keep a constant angle.

Furthermore, similarly to the processing solution supply nozzle 40, both the developer supply nozzle 20 and semiconductor wafer SW may be rotated when supplying the developer.

While the invention has been shown and described in detail, the foregoing description is in all aspects illustrative and not restrictive. It is therefore understood that numerous modifications and variations can be devised without departing from the scope of the invention.

1.-7. (canceled)

8. A substrate processing method of supplying a processing solution onto a main surface of a substrate having undergone a developing operation, comprising the steps of: (c) supplying a development stop liquid onto said substrate having undergone said developing operation; and (d) supplying an anti-static cleaning solution onto said substrate after said step (c).

9. The substrate processing method according to claim 8, wherein said anti-static cleaning solution is a solution with ions dissolved therein in such a concentration that no bubble is generated.

10. The substrate processing method according to claim 8, wherein said development stop liquid is pure water.
